(19) United States
(12) Patent Application Publication
(10) Pub. No.: US 2020/0321134 A1
(43) Pub. Date: Oct. 8, 2020

(54) FUEL PELLETS HAVING A HETEROGENEOUS COMPOSITION AND RELATED METHODS

(71) Applicant: Battelle Energy Alliance, LLC, Idaho Falls, ID (US)

(72) Inventors: Robert C. O'Brien, Idaho Falls, ID (US); Patrick J. Moo, DeLand, FL (US); Adrian R. Wagner, Idaho Falls, ID (US); Randall Scott, Idaho Falls, ID (US); Scott R. Wilde, Idaho Falls, ID (US)

(21) Appl. No.: 16/372,730

(22) Filed: Apr. 2, 2019

(51) Int. Cl. G21C 3/62; G21C 3/04; G21C 3/16

(52) U.S. Cl. CPC G21C 3/623; G21C 3/16; G21C 3/045

(57) ABSTRACT

A nuclear fuel element for a nuclear reactor comprises a body having a first region and a second region surrounded by the first region. The first segment comprises a poison material, and the second region comprises a nuclear fuel material and is substantially free of the poison material. A nuclear fuel element for use in a nuclear reactor comprises the body and a cladding material at least partially surrounding the body. Related methods of forming the nuclear fuel pellet include additive manufacturing processes to form first and second segments.

### STATEMENT REGARDING FEDERALLY SPONSORED RESEARCH OR DEVELOPMENT

This invention was made with government support under Contract Number DE-AC07-05-1D14517 awarded by the United States Department of Energy. The government has certain rights in the invention.

### TECHNICAL FIELD

Embodiments of the disclosure relate generally to nuclear fuel pellets. More particularly, embodiments of the disclosure relate to nuclear fuel pellets having a heterogeneous composition of nuclear fuel materials and poison materials therein and related methods of manufacturing such nuclear fuel pellets.

### BACKGROUND

Nuclear reactors are used to generate power (e.g., electrical power) using nuclear fuel materials. For example, heat generated by nuclear reactions carried out within the nuclear fuel materials may be used to boil water, and the steam resulting from the boiling water may be used to rotate a turbine. Rotation of the turbine may be used to operate a generator for generating electrical power.

Nuclear reactors generally include what is referred to as a “nuclear core,” which is the portion of the nuclear reactor that includes the nuclear fuel material and is used to generate heat from the nuclear reactions of the nuclear fuel material. The nuclear core may include a plurality of fuel rods, which include the nuclear fuel material.

Most nuclear fuel materials include one or more of the elements of uranium and plutonium (although other elements such as thorium are also being investigated). There are, however, different types or forms of nuclear fuel materials that include such elements. For example, nuclear fuel pellets 12, as illustrated in FIG. 1, may comprise ceramic nuclear fuel materials. Ceramic nuclear fuel materials include, among others, radioactive uranium oxide (e.g., uranium dioxide). Nuclear fuel pellets 12 may also comprise poison materials distributed throughout.

The nuclear reaction including the nuclear fuel pellets 12 involves the disintegration of the nuclear fuel material into two or more fission products of lower mass number. Among other things the reaction process also includes a net increase in the number of available free neutrons, which are the basis for a self-sustaining reaction. To extend the life of the nuclear reaction of the nuclear fuel material, parasitic neutron-capturing elements may be added to the nuclear fuel material to compensate for initial higher reactivity of the nuclear fuel material. Such neutron-capturing elements include the poison material (e.g., burnable absorbers) having a high probability (or cross section) for absorbing neutrons while producing no new or additional neutrons or changing into new poisons as a result of neutron absorption.

During the nuclear reaction, heat is generated within the fuel pellets 12 and, more particularly, a thermal gradient is generated within the fuel pellets 12 such that the greatest heat is generated in a central region (e.g., lateral and/or longitudinal center) of the fuel pellets 12. Further, because poison materials generally have a lower melting point relative to nuclear fuel materials within the nuclear fuel pellets 12, the nuclear fuel pellets 12 soften as the heat generated therein increases. The combination of the fuel pellets 12 softening and generation of the thermal gradient contributes to deformation of the nuclear fuel pellets 12 such that the pellets 12 deform into a generally hourglass shape in which the fuel pellets 12 contract inwardly toward the lateral and longitudinal center of the fuel pellets 12 and the lateral and longitudinal ends of the fuel pellets 12 swell outwardly, as illustrated in FIG. 1. This deformation may result in thermal cracking 18 of the fuel pellets 12, in contact between the fuel pellets 12 and cladding 14 enclosing the fuel pellets 12, and deformation of the cladding 14, such as the generation of undulating ridges 16. Contact between the fuel pellets 12 and cladding 14 may lead to pellet-cladding mechanical interaction drive failures of a fuel rod 10.

### BRIEF SUMMARY

Embodiments disclosed herein include a nuclear fuel element for a nuclear reactor. The nuclear fuel element comprises a pellet body having a first region and a second region surrounded by the first region. The first region comprises a poison material and a nuclear fuel material, and the second region comprises the nuclear fuel material and is substantially free of the poison material.

In additional embodiments, a nuclear fuel element for use in a nuclear reactor comprises a body and a cladding material at least partially surrounding the body. The body comprises a poison material and a nuclear fuel material. A central region of the body proximate a central axis of the body is substantially free of the poison material.

Embodiments disclosed herein include methods of forming a nuclear fuel element, comprises additively manufacturing a first segment of the nuclear fuel element and additively manufacturing a second segment of the nuclear fuel element. The first segment has a first concentration of a dopant dispersed within a nuclear fuel material, and the second segment has a second concentration of the dopant dispersed within the nuclear fuel material. The second concentration of the dopant is greater than the first concentration of the dopant. The method further comprises disposing the first segment adjacent to the second segment and joining the first segment to the second segment to form the nuclear fuel element having a heterogeneous composition.

### BRIEF DESCRIPTION OF THE DRAWINGS

FIG. 1 is a simplified schematic diagram of a conventional fuel rod;

FIGS. 2A and 2B are simplified perspective and cross-sectional views, respectively, of a fuel pellet according to embodiments of this disclosure;

FIGS. 3A and 3B are simplified perspective and cross-sectional views, respectively, of a fuel pellet according to embodiments of this disclosure;

FIG. 4 is a simplified cross-sectional view of a fuel rod comprising fuel pellets of FIGS. 2A-3B;

FIG. 5 a simplified schematic of a system additively manufacturing fuel pellets in accordance with embodiments of the disclosure;

FIG. 6 are simplified perspective views of disassembled segments of a fuel pellet and a fuel pellet assembled from such segments; and

FIG. 7 is a simplified schematic of a system for digital light processing fuel pellets in accordance with embodiments of the disclosure.

### DETAILED DESCRIPTION

The illustrations included herewith are not meant to be actual views of any particular material, component, or system, but are merely idealized representations that are employed to describe embodiments of the disclosure.

The following description provides specific details, such as material types, material thicknesses, and processing conditions in order to provide a thorough description of embodiments described herein. However, a person of ordinary skill in the art will understand that the embodiments disclosed herein may be practiced without employing these specific details. Indeed, the embodiments of the disclosure may be practiced in conjunction with conventional fabrication techniques employed in the industry. In addition, the description provided below does not form a complete process flow, apparatus, or system for forming a nuclear fuel element, a component of a nuclear reactor core, another structure, or related methods. Only those process acts and structures necessary to understand the embodiments of the disclosure are described in detail below. Additional acts to form a nuclear fuel element (e.g., fuel pellet), a component of a nuclear reactor core, or another structure may be performed by conventional techniques. Further, any drawings accompanying the present application are for illustrative purposes only and, thus, are not drawn to scale. Additionally, elements common between figures may retain the same numerical designation.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, even at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “longitudinal” or “longitudinally” refers to a direction parallel to a longitudinal (e.g., central) axis of a component of a nuclear reactor, such as a fuel pellet as described herein.

As used herein, the term “lateral” or “laterally” refers to a direction transverse to the longitudinal axis of the nuclear reactor component, such as the fuel pellet described herein.

As used herein, “and/or” includes any and all combinations of one or more of the associated listed items.

As used herein, the term “configured” refers to a size, shape, material composition, orientation, and arrangement of one or more of at least one structure and at least one apparatus facilitating operation of one or more of the structure and the apparatus in a pre-determined way.

According to embodiments described herein, a structure comprising one or more components of a nuclear reactor (e.g., nuclear fuel element) may be formed to exhibit a compositional gradient (e.g., variant) along a longitudinal dimension (e.g., length, height) and/or along a lateral dimension (e.g., width, radius). In some embodiments, the structure may be formed in a layer-by-layer deposition process. The structure may be formed in a direct material deposition process such as 3D printing process or additive manufacturing process. By using a direct material deposition process, the structure may be formed to exhibit complex cross-sectional geometries, non-uniform external surface topographies, and compositional features that are unobtainable or difficult to manufacture according to conventional methods.

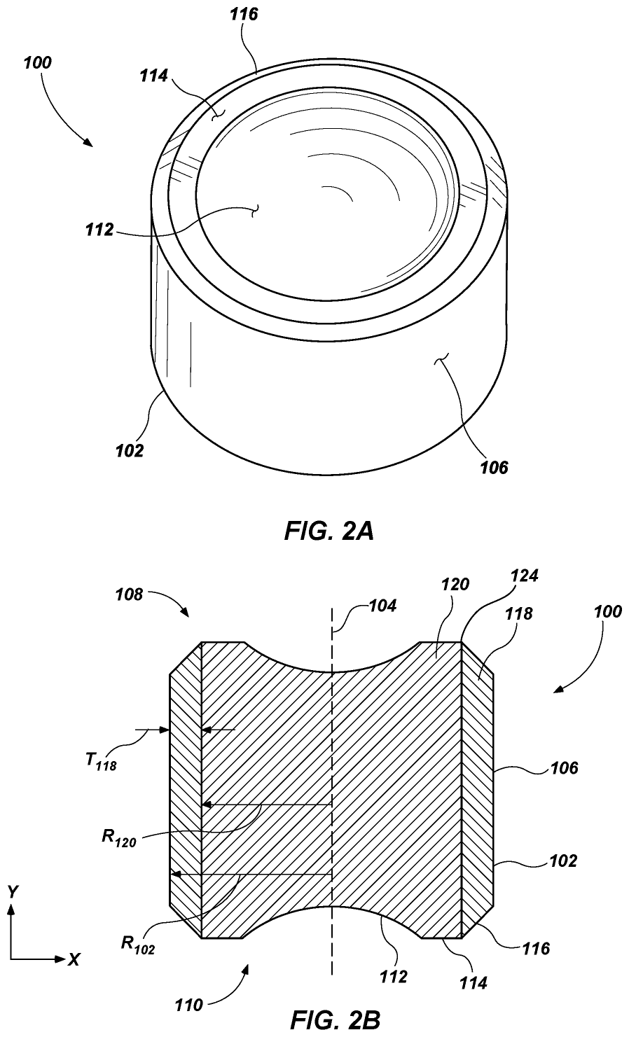

By way of non-limiting example, the structure formed according to embodiments of this disclosure may comprise a nuclear fuel element. The nuclear fuel element may comprise a nuclear fuel pellet. FIGS. 2A and 2B illustrate a fuel pellet 100 according to embodiments of the disclosure in a simplified perspective view and cross-sectional view, respectively. The fuel pellet 100 comprises a pellet body 102 having a central axis 104 extending longitudinally therethrough. The pellet body 102 comprises a substantially cylindrical sidewall 106 extending between an upper end face 108 and a lower end face 110. In some embodiments, a recessed surface 112 may be defined in the end faces 108, 110. The recessed surface 112 may have an arcuately shaped cross-section, as best illustrated in FIG. 2B. A substantially planar surface 114 may extend circumferentially (e.g., annularly, concentrically) about the recessed surface 112. The substantially planar surface 114 may extend substantially perpendicular to the central axis 104 of the fuel pellet body 102. A chamfered surface 116 may extend circumferentially about the substantially planar surface 114. The chamfered surface 116 may be oriented at an angle and extend between respective end faces 108, 110 and the cylindrical sidewall 106. Additional features of a fuel pellet 100 as known in the art and but which are not illustrated or described herein, may be formed in the fuel pellet 100 including, but not limited to, an aperture extending axially therethrough.

The fuel pellet 100 may include (e.g., be comprised of) any appropriate nuclear fuel material. In some embodiments, the nuclear fuel material may comprise one or more of uranium, zirconium, tungsten, tantalum, iridium, uranium dioxide (UO₂), uranium oxide (e.g., U₃O₈), uranium nitride (e.g., UN, U₂N₃, etc.), uranium silicide (e.g., U₃Si₂), uranium borides (e.g., UB₂, UB₄), a transuranic material (e.g., plutonium, plutonium oxide), thorium, oxides thereof, another nuclear fuel material, or combinations thereof. The fuel pellet 100 may also include (e.g., be comprised of) any appropriate additive, or dopant, material. In some embodiments, the additive material may be a poison material, such as a burnable poison material. In some embodiments, the poison material may comprise one or more of boron, gadolinium, gadolinium oxide (Gd₂O₃), boron carbide (B₄C), another material exhibiting a high thermal neutron absorption cross-section, and combinations thereof. Other poison materials may include krypton, molybdenum, neodymium, hafnium, another neutron absorber, or combinations thereof. The poison material may be disposed in a region (e.g., segment) of the fuel pellet body 102 in which it will have the greatest impact on the nuclear reaction within a nuclear reactor (e.g., to enhance neutronic efficiency of the nuclear fuel material and the poison material therein) and may be excluded from other regions of the fuel pellet body 102. In some embodiments, the poison material may be excluded from a central region (e.g., a lateral and/or longitudinal center located proximate to the central axis 104) of the pellet body 102 so as to inhibit deformation (e.g., hour-glassing) of the fuel pellet 100. In other embodiments, the poison material may also be excluded from axial ends of the pellet body 102.

Accordingly, the fuel pellet 100 may be heterogeneous in composition across a height thereof (e.g., axially, in the Z direction) and/or across a width thereof (e.g., laterally, in the X direction), such that amounts (e.g., concentrations) of one or more elements thereof are non-uniform (e.g., vary, change) within the pellet body 102. The heterogeneity of the pellet body 102 may be substantially undetectable by visual inspection (e.g., no clear delineation of first and second regions 118, 120), but may be detectable by conventional spectroscopy or spectrometry techniques. A boundary between regions of different compositions within the fuel pellets may generally have a roughness at least partially defined by the microstructure of the pellet body 102. Fine-grained and uniformed materials may exhibit a smoother or more uniform boundary, and coarse-grained materials may exhibit a rougher boundary. Some irregularity of the boundary may also be attributable to different particle sizes in various regions of the fuel pellet 100.

As illustrated in FIGS. 2A and 2B, the fuel pellet body 102 comprises a first region 118 having a first composition and second region 120 having a second composition different from the first composition. The first region 118 may define a laterally outermost region of the pellet body 102, and the second region 120 may define a laterally innermost region of the pellet body 102 adjacent to the first region 118. The first region 118 may be substantially annular and may encircle (e.g., extend circumferentially about) the second region 120. The first region 118 and the second region 120 may be concentrically arranged about the central axis 104 of the pellet body 102.

The first region 118 may comprise one or more of the poison materials as previously identified herein. In some embodiments, the first region 118 may be substantially free of a nuclear fuel material such that the first region 118 consists essentially of the poison material. In other embodiments, the first region 118 may comprise a nuclear fuel material mixed with (e.g., doped with) the poison material. The second region 120 may comprise a nuclear fuel material, such as one or more of the nuclear fuel materials previously identified herein, and may be substantially free (e.g., entirely free) of the poison material. Accordingly, as will be described herein, forming the fuel pellet 100 such that a lateral and longitudinal center thereof is substantially free (e.g., entirely free) of the poison material inhibits deformation (e.g., hour-glassing) of the fuel pellet 100.

In some embodiments, the first region 118 may be substantially homogeneous (e.g., substantially uniform) in composition across a width and/or along a height thereof. In other embodiments, the second region 120 may be compositionally graded (e.g., exhibit a compositional gradient) laterally (e.g., across a width) and/or longitudinally (e.g., along a height). For example, the composition of the first region 118 may be graded such that the concentration of poison material within the nuclear fuel increases as a distance from the center (e.g., distance from the central axis 104) of the pellet body 102 increases. Accordingly, the composition of the poison material within the first region 118 may be greatest at a periphery of the fuel pellet body 102 and decreases as the distance from the center of the pellet body 102 decreases. In such embodiments, the first region 118 may comprise up to (e.g., comprise a maximum of) about 8 weight percent (wt %), about 15 wt %, about 20 wt %, about 25 wt %, or up to about 100 wt % of the poison material with a remainder of the first region 118 comprising the nuclear fuel material.

As the concentration of the poison material relative to the concentration of the nuclear fuel within the first region 118 increases, a volume of the first region 118 may decrease. In some embodiments, a thickness T₁₁₈ of the first region 118 may decrease and a radius R₁₂₀ of the second region 120 may increase correspondingly as the concentration of the poison material within the first region 118 increases. In some embodiments, the thickness T₁₁₈ of the first region 118 may extend in a range from about 0.3 mm to about 3.7 mm and, more particularly, may be about 0.3 mm, about 1.13 mm, about 1.6 mm, or about 3.7 mm. Expressed as a function of a radius R₁₀₂ of the fuel pellet body 102, the thickness of the first region 118 may extend along up to 7.3 percent, up to about 27.6 percent, up to about 40.0 percent, or up to about 90.0 percent of the radius R₁₀₂ of the fuel pellet body 102 and the second region 120 may extend along a remainder of the radius R₁₀₂ of the fuel pellet body 102.

The concentration of poison material within the first region 118 may decrease with decreasing distance from the central axis 104. In some embodiments, the concentration of poison material within the first region 118 may decrease until the concentration of poison material within the first region 118 is substantially zero at which a transition (e.g., interface 124) between the first region 118 and the second region 120 is defined. The reduced concentration of poison material in a region of the first region 118 adjacent to the second region 120 may mitigate delamination and spalling between the first and second regions 118, 120 of the pellet body 102 due to the dissimilar material compositions of the first and second regions 118, 120.

Alternatively or additionally, the first region 118 may be compositionally graded (e.g., exhibit a compositional gradient) in an axial direction. In some embodiments, the composition of the first region 118 may be graded such that the concentration of poison material within the first region 118 may decrease in an axial dimension such that the concentration of poison material decreases with decreasing distance from respective end faces 108, 110. Accordingly, the composition of the poison material within the first region 118 may be greatest at an axial center of the first region 118 and decreases as the distance from the center of the end faces 108, 110 decreases.

In some embodiments, the first region 118 and the second region 120 may extend axially (e.g., parallel to the central axis 104) along substantially an entire height H₁₀₂ of the pellet body 102 from the upper end face 108 to the lower end face 110. In other embodiments, the first region 118 may extend along less than the entire height H₁₀₂ of the pellet body 102. Expressed as a function of the height H₁₀₂, the first region 118 may extend in a range from about 80 percent to about 90 percent of the height H₁₀₂ of the pellet body 102. In some embodiments, the first region 118 may not extend to the upper end face 108 or to the lower end face 110. Rather, the regions of the pellet body 102 adjacent to the upper and lower end faces 108, 110 may be substantially (e.g., entirely) free of poison material. Accordingly, the upper and lower end faces 108, 110 may be comprised of the second region 120.

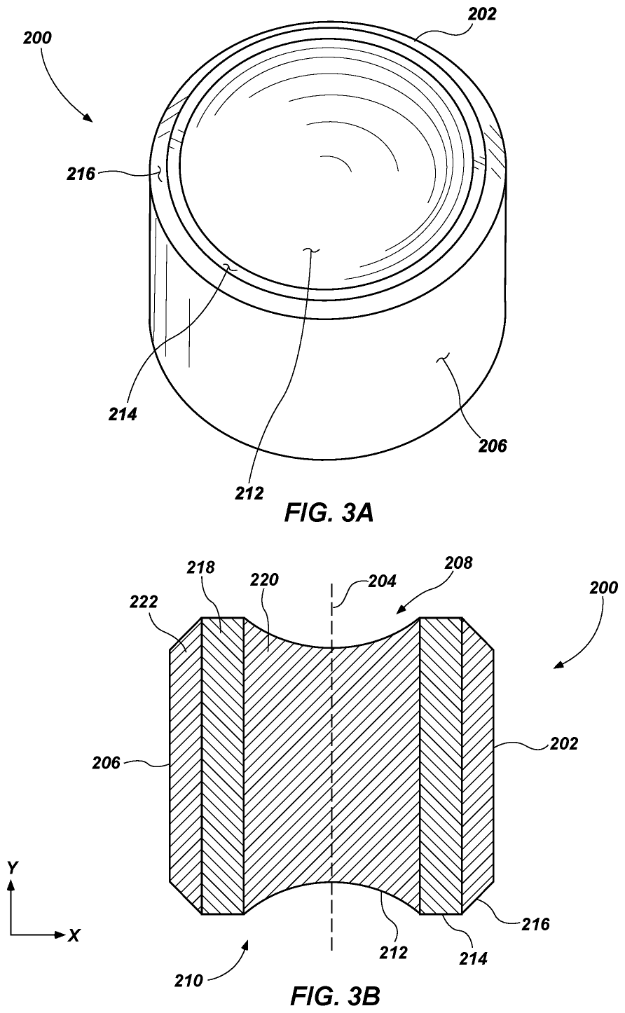

FIGS. 3A and 3B illustrate a fuel pellet 200 according to further embodiments of the disclosure in a perspective view and a cross-sectional view, respectively. Throughout the remaining description and the accompanying figures, functionally similar features (e.g., structures, devices) are referred to with similar reference numerals incremented by 100. To avoid repetition, not all features shown in FIGS. 3A and 3B are described in detail herein. Rather, unless described otherwise below, a feature designated by a reference numeral that is a 100 increment of the reference numeral of FIGS. 2A and 2B will be understood to be substantially similar to the previously-described feature.

The pellet body 202 comprises a substantially cylindrical sidewall 106 extending between an upper end face 208 and a lower end face 210. In some embodiments, an arcuate recessed surface 212 may be defined in the end faces 208, 210. A substantially planar surface 214 may extend circumferentially (e.g., annularly, concentrically) about the recessed surface 212. The substantially planar surface 214 may extend substantially perpendicular to the central axis 204 of the pellet body 202. A chamfered surface 216 may extend about the substantially planar surface 214 and may be oriented at an angle so as to extend between the end faces 208, 210 and the sidewall 206. Additional features as known in the art and not described herein, may be formed in the fuel pellet 200 including, but not limited to, an aperture extending axially therethrough.

The fuel pellet 200 may comprise a first region 218 extending between a second region 220 and a third region 222. The first region 218 may be a substantially annular region encircling (e.g., extending circumferentially about) the substantially cylindrical second region 220, and the third region 222 may be a substantially annular region encircling the first region 218. Each of the first region 218, the second region 220, and the third region 222 may be concentrically arranged about the central axis 204 of the pellet body 202. In some embodiments, the second and third regions 220, 222 may have a composition different from the first region 218. The second and third regions 220, 222 may have substantially the same composition.

The first region 218 may comprise the poison material as previously identified herein, and the second and third regions 220, 222 may comprise a nuclear fuel material as previously identified herein. The second and third regions 220, 222 may be substantially free (e.g., entirely free) of poison material such that a lateral and longitudinal center of the pellet body 202 is substantially free of poison material and that a lateral and longitudinal periphery of the pellet body 202 is substantially free of poison material. In some embodiments, the first region 218 may be substantially free of the nuclear fuel material and may consist essentially of the poison material. In other embodiments, the first region 218 may comprise a nuclear fuel material mixed with (e.g., doped with) the poison material.

In some embodiments, the first region 218 may be substantially homogeneous in composition across a width and/or along a height thereof. In other embodiments, the first region 218 may be heterogeneous in composition such that the first region 218 exhibits a compositional gradient therein as previously described with reference to the first region 118 of the fuel pellet illustrated in FIGS. 2A and 2B. In such embodiments, the first region 218 may be compositionally graded laterally (e.g., across a width) and/or longitudinally (e.g., along a height) such that the concentration of poison material within the nuclear fuel material varies across a thickness T₂₁₈ of the first region 218. In some embodiments, the composition of the first region 218 may be graded such that the greatest concentration of the poison material is disposed intermediately between the second region 220 and the third region 222. Accordingly, the concentration of poison material within the first region 218 may initially increase with increasing distance from the central axis 204 and may subsequently decrease with increasing distance from the central axis 204. In other embodiments, the composition of the first region 218 may be graded such that the greatest concentration of the poison material is provided at a periphery of the first region 218 adjacent to the third region 222. Put differently, the composition of the poison material within the first region 218 increases as the distance from the center of the pellet body 202 (e.g., distance from central axis 104) increases. Alternatively or additionally, the composition of the poison material within the first region 218 may decrease as the distance from end faces 208, 210 decreases, as previously described with reference to FIGS. 2A and 2B.

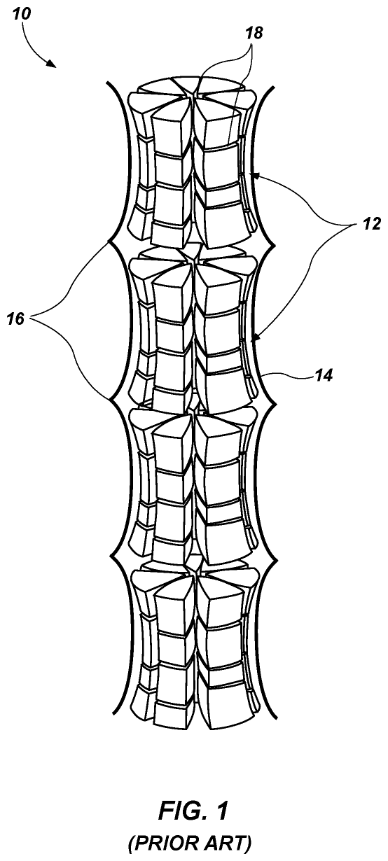

Without being bound to any particular theory, the distribution of the poison material within the pellet body 102, 202 and/or the absence of poison material in some regions of the pellet body 102, 202 inhibits deformation of the pellet body 102, 202 driven by the thermal gradient generated within the pellet body 102, 202 and, more particularly, inhibits hour-glassing of the pellet body 102, 202. As previously stated herein, the poison material may have a melting temperature less than a melting temperature of the nuclear fuel material within the pellet body 102, 202, and the greatest temperatures are generated at the center of the pellet body 102, 202 during the nuclear reaction. Accordingly, the distribution of the poison material within the pellet body 102, 202 as described herein may generate a thermal gradient that opposes (e.g., is inverse to) the lateral and longitudinal swelling that generates the hourglass deformation of the pellet body 12 having poison material distributed substantially uniformly throughout the pellet body 12 (FIG. 1). For instance, deformation may be inhibited (e.g., eliminated) by excluding the poison material, which lowers the overall melting temperature of the fuel pellets 100, 200, from the region of the fuel pellets 100, 200 where the highest temperatures are generated (e.g., the center of the fuel pellets 100, 200). Alternatively or additionally, the distribution of the poison material within the pellet body 102, 202 may generate a uniform temperature distribution within the pellet body 102, 202 that inhibits deformation thereof.

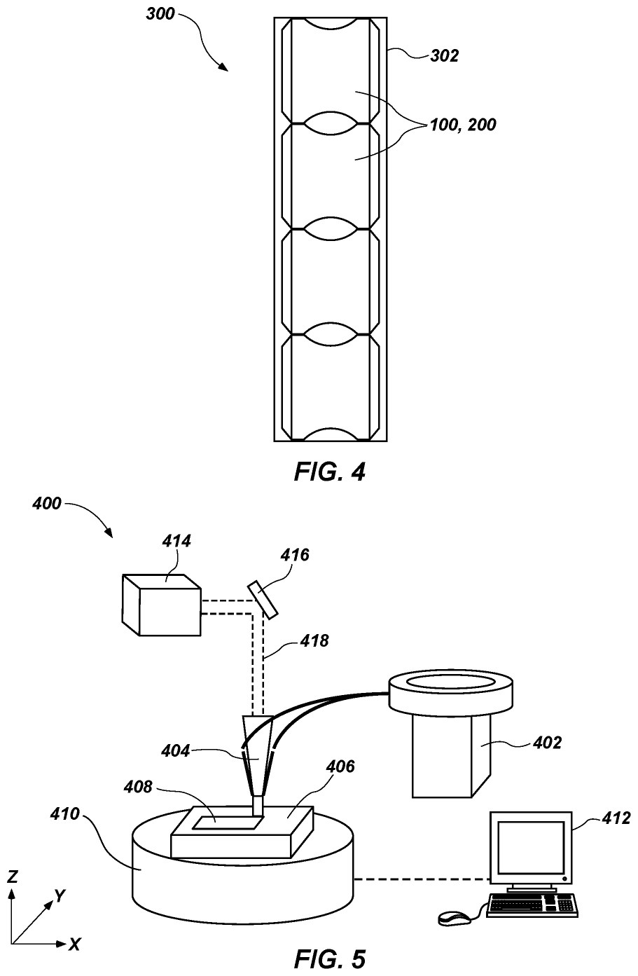

The fuel pellets 100, 200 may be used in a fuel rod 300, as illustrated in FIG. 4, in, for example, a fast-neutron reactor, a light water reactor, a modular nuclear reactor, a space reactor, a micro reactor, or other nuclear reactor. The fuel rod 300 may comprise fuel pellets 100, 200 according to embodiments of the disclosure. The fuel pellets 100, 200 may be at least partially surrounded (e.g., entirely surrounded, encapsulated) by cladding 302.

The nuclear fuel pellets and fuel rods according to the foregoing embodiments may be at least partially formed by an additive manufacturing process. The additive manufacturing process used to form the nuclear fuel pellets 100, 200, or at least a portion thereof, may be a printing process, such as an ink jet process (e.g., an aerosol jet printing process), a laser additive manufacturing process, and/or an electron beam additive manufacturing process. In some embodiments, the nuclear fuel pellets may be formed using a system 400 as illustrated in FIG. 5. The system 400 may also be used to additively manufacture, for example, a nuclear fuel pellets at least partially surrounded by cladding, a fuel rod, other components of a nuclear reactor, or combinations thereof.

The system 400 includes a powder feed 402 comprising sources of one or more powder constituents used to form a product to be additively manufactured. The powder feed 402 may comprise particles of a nuclear fuel material, particles of an additive material (e.g., poison material), particles of a cladding material, or combinations thereof.

Where the powder feed 402 comprises a nuclear fuel, the powder feed may include particles of uranium, zirconium, tungsten, tantalum, iridium, uranium dioxide (UO₂), uranium oxide (e.g., U₃O₈), uranium nitride (e.g., UN, U₂N₃, etc.), uranium silicides (e.g., U₃Si₂), uranium borides (e.g., UB₂, UB₄), a transuranic material (e.g., plutonium, plutonium oxide), thorium, oxides thereof, another nuclear fuel material, or combinations thereof.

Where the powder feed 402 comprises a nuclear poison material, the powder feed may include particles of a burnable poison material such as boron, gadolinium, gadolinium dioxide (Gd₂O₃), boron carbide (B₄C), another material exhibiting a high thermal neutron absorption cross-section, and combinations thereof. In other embodiments, the powder feed 402 includes poisons such as krypton, molybdenum, neodymium, hafnium, another neutron absorber, or combinations thereof.

Where the powder feed 402 includes particles of a cladding material, the powder feed 402 may include particles of zirconium, a stainless steel alloy (e.g., 316 stainless steel), nickel, iron, chromium, molybdenum, titanium, tungsten, or combinations thereof. Where the powder feed 402 includes particles of a fission barrier material, the powder feed 402 may include particles of zirconium, vanadium, another material, or combinations thereof.

In some embodiments, the powder feed 402 is in fluid communication with a powder delivery nozzle 404. The powder feed 402 may be provided to the powder delivery nozzle 404 as a mixture having a desired composition. In other embodiments, the powder may be provided to the powder delivery nozzle 404 as separate components (e.g., uranium dioxide and gadolinium oxide) that are mixed at the powder delivery nozzle 404.

The powder delivery nozzle 404 may be positioned and configured to deliver the powder feed 402 to a surface of a substrate 406 on which a structure 408 is formed. The powder delivery nozzle 404 may be configured to deliver more than one powder feed 402 composition to the substrate 406 concurrently. In other words, the powder delivery nozzle 404 may be in fluid communication with sources of powders having more than one composition and may be used to form the structure 408 having one or more different composition therethrough. Accordingly, although only one powder delivery nozzle 404 is illustrated in FIG. 5, in some embodiments, the system 400 includes more than one powder delivery nozzle 404, each powder delivery nozzle 404 in fluid communication with a powder feed 402 having a different composition than the other powder delivery nozzles 404. By way of nonlimiting example, in some embodiments, the system 400 includes a powder delivery nozzle 404 in fluid communication with a powder feed 402 comprising a nuclear fuel material and a powder delivery nozzle 404 in fluid communication with a powder feed 402 comprising a poison material.

In other embodiments, the powder delivery nozzle 404 may be in fluid communication with a plurality of powder feed 402 materials. In some such embodiments, the powder delivery nozzle 404 is configured to receive powder from different powder feed 402 materials and configured to concurrently dispose powders of different compositions on the substrate 406.

In use and operation, the relative concentration of a powder feed 402 comprising the poison material relative to the concentration of the powder feed 402 comprising the nuclear fuel material may be adjusted (e.g., varied) during deposition of the respective layers to form the structure 408 having a heterogeneous composition. In some embodiments, a powder mixture of the poison material and the nuclear fuel may be disposed on a surface of the substrate 406. The substrate 406 may comprise a previously-formed layer of the structure 408.

The substrate 406 and the structure 408 are disposed on a table 410, which may comprise, for example, a triaxial numerical control machine. Accordingly, the table 410 may be configured to move along at least three axes. By way of nonlimiting example, the table 410 may be configured to move in the x-direction (i.e., left and right in the view illustrated in FIG. 5), the y-direction (i.e., into and out of the page in the view illustrated in FIG. 5), and the z-direction (i.e., up and down in the view illustrated in FIG. 5). Further, the table 410 may be configured to rotate about a vertical axis, in the z-direction.

The table 410 may be operably coupled with a central processing unit 412 configured to control the table 410. In other words, movement of the table 410 may be controlled through the central processing unit 412, which may comprise a control program for a processor including operating instructions for movement of the table 410.

The system 400 may further include an energy source 414 configured to provide energy to the powder on the substrate 406. Energy (e.g., electromagnetic energy) from the energy source 414 may be directed to the substrate 406 and the structure 408 through a mirror 416, which may orient the energy to the substrate 406. The energy source 414 may comprise, for example, a laser (e.g., selective laser additive manufacturing), an electron beam, a source of microwave energy, or another energy source. Powder from the powder delivery nozzle 404 is disposed on the substrate 406 and exposed to energy (illustrated by broken lines 418) from the energy source 414.

Although FIG. 5 illustrates that the table 410 is operably coupled with the central processing unit 412 to effect movement of table 410, the disclosure is not so limited. In other embodiments, the central processing unit 412 is operably coupled with the powder delivery nozzle 404 and the energy source 414 and the powder delivery nozzle 404 and the energy source 414 is configured to move in one or more directions (e.g., the x-direction, the y-direction, and the z-direction) responsive to receipt of instructions from the central processing unit 412. In some such embodiments, one or some of the powder delivery nozzle 404, the energy source 414 and the table 410 may be configured to move in one or more directions. Movement of one or more of the powder delivery nozzle 404, the energy source 414, and the table 410 may facilitate forming the structure 408 to have a desired composition and geometry.

In use and operation, a layer of powder from the powder feed 402 and expelled by the powder delivery nozzle 404 may be formed over the substrate 406 and subsequently exposed to energy from the energy source 414 to form inter-granular bonds between particles of the layer of powder. In other embodiments, the powder is exposed to energy from the energy source 414 substantially simultaneously with delivery of the powder to the surface of the substrate 406 or substantially immediately thereafter. In some such embodiments, portions of the layer of the structure 408 being formed may be exposed to energy from the energy source 414 prior to formation of the entire layer of the structure 408. At least one of the energy source 414 and the table 410 may be configured to move responsive to instructions from the central processing unit 412.

After formation of the layer of the structure 408, the substrate 406 is moved away from the energy source 414, such as by movement of one or both of the table 410 and the energy source 414 responsive to receipt of instructions from the central processing unit 412. Additional powder may be delivered to the surface of the previously formed layer of the structure 408 in a desired pattern and exposed to energy from the energy source 414 to form inter-granular bonds between adjacent particles of the powder in the layer and between particles of the powder in the layer and the underlying layer of the structure 408.

Accordingly, a method of forming a fuel pellet using the system 400 comprises disposing a first powder comprising particles of a poison material on the substrate 406 and exposing the powder to energy from the energy source 414 to form a first layer. Exposing the powder to the energy source 414 comprises forming inter-granular bonds between the particles of the poison material. The method further comprises disposing a second powder comprising particles of a nuclear fuel material on the substrate 406 over the first layer and exposing the second powder to energy from the energy source 414 to form a second layer. Exposing the powder to the energy source 414 comprises forming inter-granular bonds between the particles of the nuclear fuel material and between the particles of the nuclear fuel material and the first layer. Steps of depositing powder on the substrate 406 and exposing the powder to energy from the energy source 414 may be repeated until the structure 408 having a desired size, shape, and composition is formed.

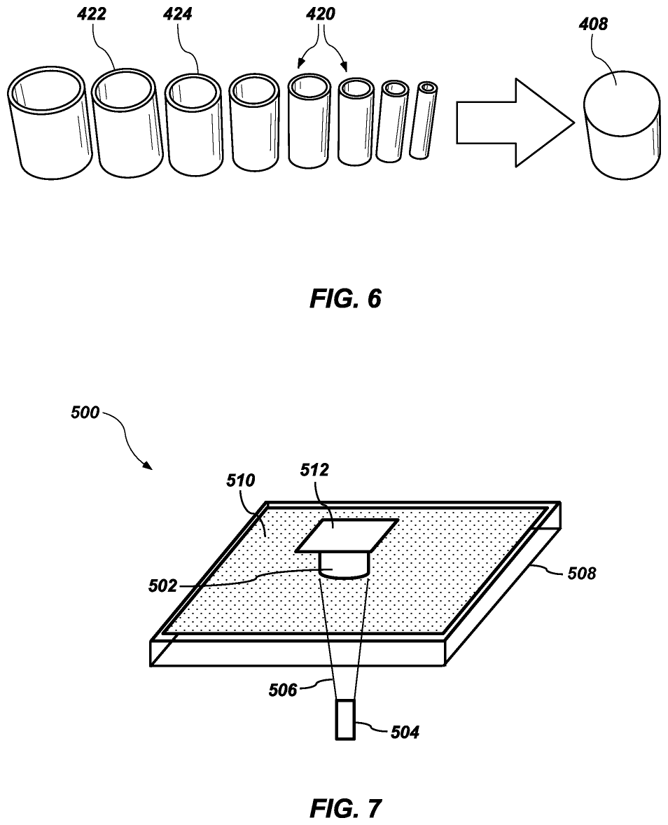

FIG. 6 illustrates the structure 408 that may be formed from a plurality of structure segments 420. As previously described herein, one or more regions of the structure 408 may be formed to exhibit a different composition than one or more other regions of the structure 408. Accordingly, each of the structure segments 420 may be formed to have a different composition. In some embodiments, different portions of one segment 420 of the structure 408 may exhibit a different composition than other portions of the same segment 420. By way of nonlimiting example, where the structure 408 comprises a fuel pellet, a portion (e.g., a peripheral region, an annular region) of the fuel pellet may comprise a poison material (e.g., gadolinium oxide) and another portion (e.g., a central region) may comprise a nuclear fuel (e.g., uranium dioxide) and may be substantially free of the poison material. Also as previously described herein, a region of the structure 408 comprising the poison material may be heterogeneous in compositions (e.g., exhibit a compositional gradient) across a thickness thereof.

The segments 420 may be formed to have similar shapes and different dimensions. For example, the segments 420 may be formed such that segments 420 having larger dimensions may be disposed about segments 420 having smaller dimensions. In some embodiments, adjacent segments 420 may be selected to have dimensions such that the segments 420 when assembled abut against one another. The shape of the segments 420 is selected such that the segments 420 may be concentrically arranged (e.g., laterally arranged) and may share a common central axis. As illustrated in FIG. 6, a first cylindrical segment 422 may be selected to have an inner diameter that is substantially equal to an outer diameter of a second, smaller cylindrical segment 424. While the fuel pellets have been illustrated to be generally cylindrical sidewalls, the fuel pellets of the present disclosure are not so limited. The fuel pellets may be polygonal in shape such that lateral side walls of the fuel pellets may be triangular, rectangular, pentagonal, hexagonal, and so forth. Further, while the fuel pellets have been described as being formed in concentric layers, the fuel pellets may also be formed in layers that may be stacked or otherwise longitudinally arranged to abut against each other to build up dimensions of the fuel pellet along the longitudinal axis.

Each segment (e.g., layer) of the structure 408 may have a thickness, which may be either a lateral dimension or a longitudinal dimension, of between about 25 μm (about 0.001 inch) and about 2 mm (about 0.079 inch), such as between about 25 μm (0.001 inch) and about 500 μm (about 0.020 inch), such as between about 25 μm and about 50 μm, between about 50 μm and about 100 μm, between about 100 μm and about 200 μm, between about 200 μm and about 300 μm, between about 300 μm and about 400 μm, or between about 400 μm and about 500 μm. Accordingly, the structure 408 may be formed one layer at a time, each layer having a thickness between about 25 μm and about 500 μm.

In embodiments in which the structure 408 is formed from the plurality of segments 420, the segments 420 may be assembled (e.g., stacked, nested) and subject to a consolidation process to join (e.g., laminate, bond, couple) the segments 420 and form a unitary structure 408. Further, the structure 408, or at least a portion thereof such as the segments 420, may be formed in an uncured state.

In some embodiments, the structure 408, or at least a portion thereof such as the segments 420, may not be formed to exhibit a full theoretical density using the additive manufacturing process described herein. For example, the structure 408 and/or segments 420 may be formed in an uncured state. Accordingly, after fabrication of the structure 408, at least a portion of the structure 408 may be exposed to annealing conditions (e.g., sintering) to increase the density of the structure 408 and reduce a porosity of the structure 408, although some level of porosity may remain after the sintering process. In such embodiments, the sintering process may increase a density of the structure to a theoretical density as high as about 98%, about 99%, or even about 100%. The sintering process may also be a curing or debinding process in which any uncured materials, such as a resin, is used to form the segments 420. The sintering process may comprise a hot isostatic pressing, pressureless sintering, spark plasma sintering, or one or more other densification processes. As used herein, the term “pressureless sintering” means and includes sintering under pressures of about 5 pounds per square inch gauge (psig) or less. The spark plasma sintering process may include a spark plasma sintering process as described in U.S. Pat. Pub. No. 2017/0369381, entitled “Methods of forming Silicon Carbide by Spark Plasma Sintering, Methods of Forming Articles Including Silicon Carbide by Spark Plasma Sintering, and Related Structures,” filed Jun. 28, 2016, the entire disclosure of which is incorporated herein by this reference.

FIG. 7 illustrates a system 500 configured to form a structure 502 that forms a portion of a nuclear fuel pellets as described herein using another additive manufacturing process. The additive manufacturing process used to form the nuclear fuel pellets 100, 200, or at least a portion thereof such as segments 420, may be a digital light process (DLP). The system 500 comprises a projector 504 that projects a light 506 onto a substrate 508. The substrate 508 may comprise a film or other material that is optically transparent to the light 506. The light 506 may be a monochromatic light such as ultraviolet (UV) light. In some embodiments, the substrate 508 may comprise polyethylene terephthalate such as MYLAR® available from DuPont Teijin Films. A resin 510 may be disposed over the substrate 508. The resin 510 may comprise a photo-polymerizing (e.g., light-polymerizing) material and may include a nuclear fuel material and an additive material (e.g., poison material), which have been previously described herein, dispersed within the photo-polymerizing material. A build plate 512 may be disposed over the resin 510.

To form the structure 502, the resin 510 may be provided in a liquid or uncured form over the substrate 508. The resin 510 provided on the substrate 508 may have a thickness in a range extending from about 20 μm to about 500 μm. The build plate 512 may be brought into contact with the resin 510. The resin 510 may be exposed to the light 506 and at least partially cures (e.g., polymerizes, crosslinks) to form the structure 502. The shape of the light 506 projected onto the substrate 508 and resin 510 may be selectively tailored to the desired shape of the segment of the structure 502, such as a shape as previously described with respect to the segments 420 of FIG. 6. As the resin 510 cures, the structure 502 attaches to (e.g. is formed on) the build plate 512. Additional layers (e.g., segments) may be formed on the structure 502. In such embodiments, a distance of the build plate 512 from the substrate 508 may be increased by raising the build plate 512 and/or by lowering the substrate 508. The resin 510 may be exchanged, or additional resin 510 may be disposed on the substrate 508. The previously formed structure 502 is brought into contact with the resin 510, and the resin 510 is at least partially cured on the previously formed structure 502. The process of providing and curing additional resin may be repeated until the structure 502 is formed to a desired dimension. The structure 502 may be subject to additional processes to solidify and/or continue polymerization of the resin. For example, the structure 502 may be irradiated with a gamma radiation source, such as cobalt-60 radiation. The structure 502 may also be subject to annealing conditions as previously described herein to increase the density of the structure 502 and/or to remove the resin material from the structure such that the nuclear fuel material and the additive material remains.

As described with reference to FIG. 6, a fuel pellet may be formed of separately formed segments using the DLP system of FIG. 7. In such embodiments, a plurality of structures 502 may be subject to a consolidation process to join (e.g., laminate, bond, couple) the structures 502 and form a unitary structure.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

1. A nuclear fuel element for a nuclear reactor, comprising:
a body comprising:
a first region comprising a poison material and a nuclear fuel material; and
a second region surrounded by the first region, the second region comprising the nuclear fuel material and being substantially free of the poison material.

2. The nuclear fuel element of claim 1, further comprising a third region surrounding the first region, the third region comprising the nuclear fuel material and being substantially free of the poison material.

3. The nuclear fuel element of claim 1, wherein the second region defines a laterally central region of the body.

4. The nuclear fuel element of claim 1, wherein the first region comprises a laterally outermost region of the body.

5. The nuclear fuel element of claim 1, wherein a lateral dimension of the first region is equal to between about 7 percent and about 90 percent of a width of the body.

6. The nuclear fuel element of claim 1, wherein a longitudinal dimension of the first region is equal to between about 80 percent and about 90 percent of a height of the body.

7. The nuclear fuel element of claim 1, wherein a concentration of the poison material within the first region varies with a lateral distance from a central axis of the body.

8. The nuclear fuel element of claim 7, wherein the concentration of the poison material increases as the lateral distance from the central axis of the body increases.

9. A nuclear fuel element for use in a nuclear reactor, comprising:
a body comprising a poison material and a nuclear fuel material, wherein a central region located proximate to a central axis of the body is substantially free of the poison material; and
a cladding material at least partially surrounding the body.

10. The nuclear fuel element of claim 9, wherein the poison material comprises gadolinium oxide and the nuclear fuel material comprises uranium dioxide.

11. The nuclear fuel element of claim 9, wherein the central region of the body is encircled by an annular region, the annular region comprising the poison material and the nuclear fuel material.

12. The nuclear fuel element of claim 9, wherein a concentration of the poison material relative to the nuclear fuel material within an annular region increases with increasing distance from a central axis of the body.

13. The nuclear fuel element of claim 9, wherein a longitudinal dimension of an annular region is less than a height of the body.

14. The nuclear fuel element of claim 9, wherein a lateral dimension of an annual region is equal to between about 7 percent and about 90 percent of a lateral dimension of the body.

15. A method of forming a nuclear fuel element, comprising:
additively manufacturing a first segment of the nuclear fuel element, the first segment having a first concentration of a dopant dispersed within a nuclear fuel material;
additively manufacturing a second segment of the nuclear fuel element, the second segment having a second concentration of the dopant dispersed within the nuclear fuel material, the second concentration of the dopant greater than the first concentration of the dopant;
disposing the first segment adjacent to the second segment; and
joining the first segment to the second segment to form the nuclear fuel element having a heterogeneous composition.

16. The method of claim 15, wherein additively manufacturing the first segment and the second segment comprises:
disposing a first powder comprising particles of a poison material on a substrate;
exposing the first powder to energy from an energy source to form the first segment, the first segment comprising inter-granular bonds between the particles of the poison material;
disposing a second powder comprising particles of a nuclear fuel material on the substrate; and
exposing the second powder to energy from the energy source to form the second segment, the second segment comprising inter-granular bonds between the particles of the nuclear fuel material.

17. The method of claim 15, wherein additively manufacturing the first segment and the second segment comprises digital light processing the first segment and the second segment.

18. The method of claim 15, further comprising selecting the dopant to comprise a poison material.

19. The method of claim 17, wherein disposing the first segment adjacent to the second segment comprises disposing the first segment to be laterally adjacent to the second segment such that a concentration of the dopant varies with a lateral distance from a central axis of the nuclear fuel element.

20. The method of claim 15, wherein disposing the first segment adjacent to the second segment comprises disposing the first segment to be longitudinally adjacent to the second segment such that a concentration of the dopant varies with a longitudinal distance from a center of the nuclear fuel element along a central axis of the nuclear fuel element.
